(19) United States
(12) Patent Application Publication
(10) Pub. No.: US 2014/0017373 A1
(43) Pub. Date: Jan. 16, 2014

(54) Peeling Apparatus with Rotating Brush and Related Methods

(71) Applicant: Ajit Kumar, Windham, NH (US)

(72) Inventor: Ajit Kumar, Windham, NH (US)

(21) Appl. No.: 13/939,601

(22) Filed: Jul. 11, 2013

Related U.S. Application Data
(60) Provisional application No. 61/670,851, filed on Jul. 12, 2012.

(51) Int. Cl. A47J 17/20; A47J 17/02

(52) U.S. Cl. CPC A47J 17/20; A47J 17/02
USPC 426/479; 30/123.6

(57) ABSTRACT

A peeling apparatus and related methods of peeling a food product are provided. The peeling apparatus includes a handle and a peeling blade connected to a first end of the handle. A rotatable brush is positioned proximate to the peeling blade, wherein the rotatable brush is rotatable about an elongated central axis, and wherein the elongated central axis is substantially parallel to a length of the peeling blade.

### CROSS REFERENCE TO RELATED APPLICATION

This application claims benefit of U.S. Provisional Application Ser. No. 61/670,851, entitled, “Peeling Apparatus with Rotating Brush and Associated Methods Thereof” filed Jul. 12, 2013, the entire disclosure of which is incorporated herein by reference.

### FIELD OF THE DISCLOSURE

The present disclosure is generally related to peeling apparatuses and more particularly is related to a peeling apparatus with a rotating brush and related methods.

BACKGROUND OF THE DISCLOSURE

A variety of devices are available for peeling food items, namely fruits and vegetables. Commonly, these conventional devices are simplistic in nature, having relatively simple designs with few moving parts. Conventional peeling devices are generally available in two styles: a traditional straight design and a less traditional Y-shaped design. Each of the peelers has a handle that supports a peeling blade. The Y-shaped peeler has a forked or Y-shaped support that allows the blade to be positioned perpendicular to the handle. Some variations on the conventional peeler design exist, such as peelers with swiveling blades, peelers with stationary food-scrubbing brushes, and peelers with multiple blades of different varieties.

While the simplistic design of the peeler may provide benefits, such as with manufacturing and cost, the designs of these conventional devices often have numerous shortcomings. For example, as the peeler is used, the peelings from the food item often become stuck or clogged within a slot in the blade of the peeler or between the peeler blade and the portion of the handle that supports the peeler, especially for Y-shaped designs. Peels becoming stuck within the peeler can render it functionless and preventing convenient operation, since the obstructing peeling may prevent the blade from slicing into the food product. The user of the peeler is then required to remove the clogged peelings from the blade, which subjects them to not only the frustration of inefficiency and inconvenience, but also the risk of contacting the blade and suffering an injury.

Thus, a heretofore unaddressed need exists in the industry to address the aforementioned deficiencies and inadequacies.

### SUMMARY OF THE DISCLOSURE

Embodiments of the present disclosure provide a peeling apparatus and related methods of peeling food products. Briefly described, in architecture, one embodiment of the system, among others, can be implemented as follows. The peeling apparatus includes a handle. A peeling blade is connected to a first end of the handle. A rotatable brush is positioned proximate to the peeling blade, wherein the rotatable brush is rotatable about an elongated central axis, and wherein the elongated central axis is substantially parallel to a length of the peeling blade.

The present disclosure can also be viewed as providing a food product peeling apparatus. Briefly described, in architecture, one embodiment of the apparatus, among others, can be implemented as follows. A handle has a substantially hollow interior portion. An electric motor is positioned within the hollow interior portion. A battery is positioned within the hollow interior portion and electrically connected to the electric motor. An activation switch is electrically connected to at least one of the electric motor and the battery, wherein activation of the activation switch rotates the electric motor. An elongate peeling blade is connected to a first end of the handle. An elongate rotatable brush is positioned substantially parallel to the elongate peeling blade, wherein the rotatable brush is rotatable about an elongated central axis, and wherein the elongated central axis is substantially parallel to a length of the peeling blade.

The present disclosure can also be viewed as providing a method of peeling a food product. In this regard, one embodiment of such a method, among others, can be broadly summarized by the following steps: providing a peeling apparatus having a handle, a peeling blade attached to a first end of the handle, wherein the peeling blade has a slot therein, and a rotatable brush positioned proximate to the first end of the handle, wherein the rotatable brush is rotatable about an elongated central axis, and wherein the elongated central axis is substantially parallel to the peeling blade; sliding the peeling blade along a surface of a food product, whereby a food product peeling moves through the slot within the peeling blade; and contacting the food product peeling with the rotatable brush, thereby moving the food product peeling out of the slot.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a cross-sectional illustration of a peeling apparatus, in accordance with a first exemplary embodiment of the present disclosure.

FIG. 2 is a side view illustration of a peeling apparatus, in accordance with the first exemplary embodiment of the present disclosure.

FIG. 3 is a cross-sectional illustration of a peeling apparatus, in accordance with the first exemplary embodiment of the present disclosure.

FIG. 4 is a cross-sectional illustration of a peeling apparatus, in accordance with a second exemplary embodiment of the present disclosure.

FIG. 5 is a cross-sectional illustration of a peeling apparatus, in accordance with a third exemplary embodiment of the present disclosure.

FIG. 6 is a cross-sectional illustration of a peeling apparatus, in accordance with a fourth exemplary embodiment of the present disclosure.

FIG. 7 is a cross-sectional illustration of a peeling apparatus, in accordance with the fourth exemplary embodiment of the present disclosure.

FIG. 8 is a cross-sectional illustration of a peeling apparatus, in accordance with a fifth exemplary embodiment of the present disclosure.

FIG. 9 is a cross-sectional illustration of a peeling apparatus, in accordance with the fifth exemplary embodiment of the present disclosure.

FIG. 10 is a flowchart illustrating a method of peeling a food product, in accordance with a sixth exemplary embodiment of the disclosure.

### DETAILED DESCRIPTION

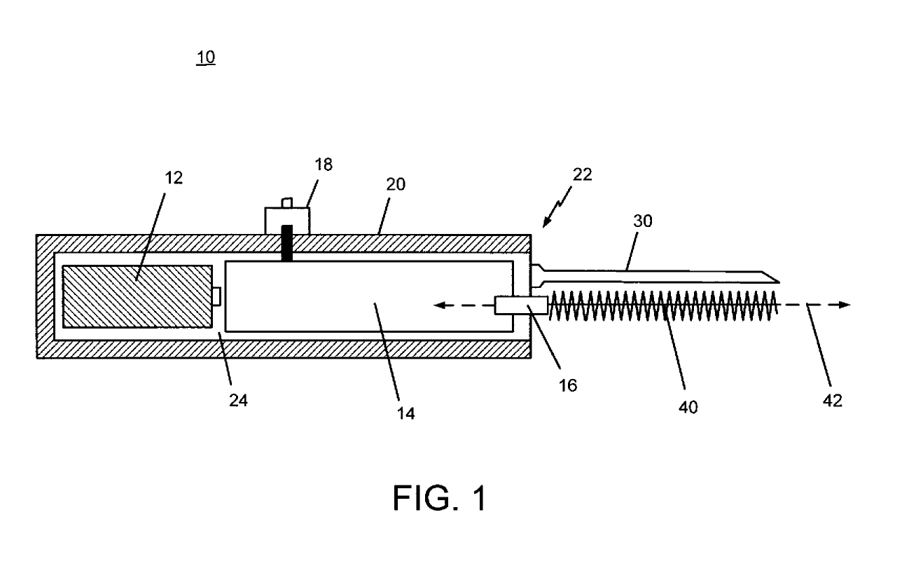

FIG. 1 is a cross-sectional illustration of peeling apparatus 10, in accordance with a first exemplary embodiment of the present disclosure. The peeling apparatus 10, which may be referred to simply as ‘apparatus 10,’ includes a handle 20. A peeling blade 30 is connected to a first end 22 of the handle 20. A rotatable brush 40 is positioned proximate to the peeling blade 30, wherein the rotatable brush 40 is rotatable about an elongated central axis 42, and wherein the elongated central axis 42 is substantially parallel to a length of the peeling blade 30.

The apparatus 10 may be used for peeling an exterior surface off of an article, commonly a food product, such as a carrot, apple, cucumber, or other food product. The apparatus 10 may be used with peeling any type of vegetable or fruit, as well as other food products that may be peeled. The apparatus 10 may also be used for peeling another portion of the food product, such as inner portion, to create shavings of the food product. For example, the apparatus 10 may be used for creating peelings of food products, sometimes referred to within the industry as shavings, such as shavings of cheeses, chocolates, or other products. The apparatus 10 may be used in a variety of industries, including residential and commercial culinary environments, without limitation. While this disclosure describes the apparatus 10 relative to uses with food product, the apparatus 10 may find success when used with non-food products too. Accordingly, depending on the intended use of the apparatus 10, it may be designed with a variety of variations and configurations, and constructed from a variety of different materials commonly known within the industry.

The handle 20 of the apparatus 10 includes at least a first end 22. The handle 20 may be an elongated structure having a solid, hollow, or partially hollow interior portion 24. The handle 20 may be designed for ergonomic use, such that it is easy to hold during use. The handle 20 may include various ergonomic or comfort features, such as a soft exterior covering, molding for finger grips, or other texturing to increase the usability of the apparatus 20 in low friction environments. Additionally, as is described relative to other embodiments of this disclosure, the handle 20 may include designs, such as those supporting a Y-shape structure for holding the peeling blade 30.

As is shown in FIG. 1, the interior portion 24 of the handle 20 may be hollow and contain components for rotating the rotatable brush 40. The components may include, but are not limited to, a power supply 12, an electric motor 14, and a rotatable output 16 positioned between the rotatable brush 40 and the electric motor 14. An activation switch 18, such as an on/off switch, may be positioned at least partially on the exterior of the handle 20 and may be in electrical or physical communication with the electric motor 14 or the power supply 12. In use, the activation switch 18 may be manipulated by a user to engage or disengage the electric motor 14, which may function from electrical power supplied by the power supply 12. When engaged, the electric motor 14 rotates the rotatable output 16 which rotates the rotatable brush 40. A variety of additional components or features may be included with the components described herein, all of which are considered within the scope of the present disclosure.

The peeling blade 30 may be attached to the first end 22 of the handle 20 at one end of the peeling blade 30. The peeling blade 30 may be stationarily attached to the handle 20 or movably connected to the handle 20. When the peeling blade 30 is movably connected to the handle 20, the movement between the peeling blade 30 and the handle 20 may allow the peeling blade 30 to swivel or partially rotate, thereby allowing convenient orientation of the peeling blade 30 with respect to a food product. The peeling blade 30 may have a slot (not shown) positioned within the peeling blade 30 to allow the peelings of the food product slip through the peeling blade 30, as is well-known in the art. In accordance with the first embodiment of the present disclosure, the peeling blade 30 may be positioned substantially parallel with the length of the handle 20. Other embodiments disclose other orientations of the peeling blade 30 to the handle 20. The peeling blade 30 may be affixed at any point on the first end 22 of the handle 20, such as at an off-centered point at the first end 22. In an off-centered position, the peeling blade 30 may allow for the rotatable brush 40 to be positioned at an approximate center of the first end 22. The rotatable brush 40 may be rotatable about the elongated central axis 42, as depicted in FIG. 1, wherein the elongated central axis 42 runs along the length of the rotatable brush 40. The rotatable brush 40 may be oriented such that the elongated central axis 42 is substantially parallel to the peeling blade 30. In this orientation, when a peeling of a food product is positioned near the peeling blade 30 or positioned within the slot (not shown) within the peeling blade 30, the peeling will be in proximate closeness to the rotatable brush 40. When the peeling of the food product is positioned at least partially between the peeling blade 30 and the rotatable brush 40, it may be contacted by the rotating brush 40 which may move the peeling from its position, causing the peeling to move away from the peeling blade 30 and the rotatable brush 40. In this fashion, the rotation of the rotatable brush 40 and its proximate closeness to the peeling blade 30 may keep the peeling blade 30 free from a build-up or clogging of peelings.

The materials of construction of the apparatus 10 may vary, but will preferably include food-grade materials or materials that are commonly used within the culinary industry. These materials may include plastics, metals, rubbers, silicone, or synthetic materials. In may be common for different components of the apparatus 10 to be constructed from different materials. For example, the peeling blade 30 may be constructed from stainless steel or ceramic, while the rotatable brush 40 may be constructed from metal, rubber, nylon, or silicon materials, and the handle 20 may be constructed from plastic. Any variation of the construction and manufacturing of the apparatus 10, including the materials used, processes use, performance, and/or functions, are considered within the scope of the present disclosure.

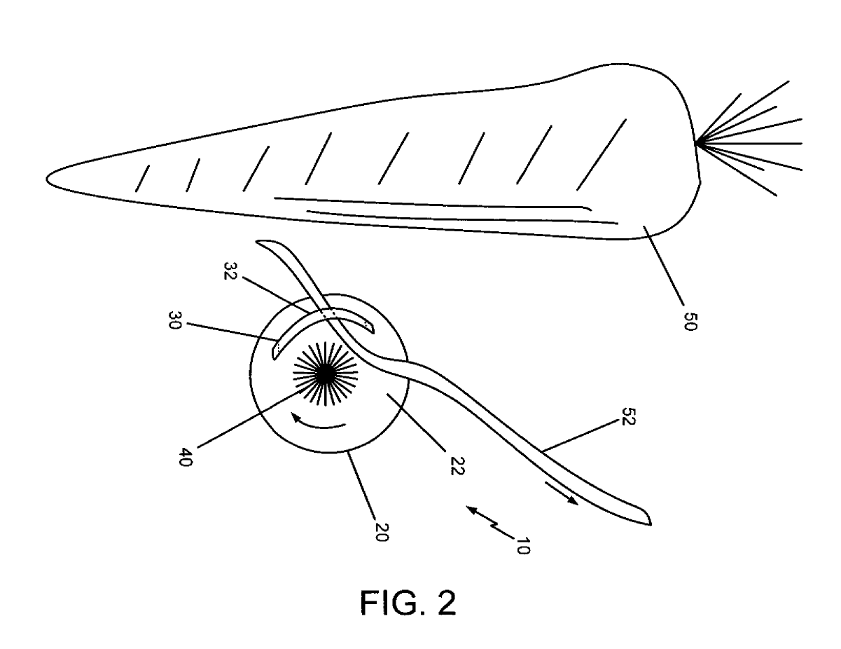

FIG. 2 is a side view illustration of the apparatus 10 of FIG. 1, in accordance with the first exemplary embodiment of the present disclosure. In particular, FIG. 2 depicts the apparatus 10 in use with a food product 50, wherein a peeling 52 of the food product 50 has been removed from the exterior surface of the food product 50. As can be seen, the peeling 52 is positioned within a slot 32 within the peeling blade 30. When the peeling 52 moves to a position between the peeling blade 30 and the rotatable brush 40 it will contact the rotatable brush 40. As the rotatable brush 40 rotates, depicted with the directional arrow, the peeling 52 will be forced out of the position between the peeling blade 30 and the rotatable brush 40. The movement of the peeling 52 is depicted by a directional arrow in FIG. 2. In use, it may be preferable to rotate the rotatable brush 40 in a direction that allows the portion of the rotatable brush 40 that contacts the peeling 52 to move in the same direction as the peeling 52 moves through the peeling blade 30. In other words, the rotation of the rotatable brush 40 should assist with the natural movement of the peeling 52 through the peeling blade 30, as opposed to moving against the natural movement of the peeling 52.

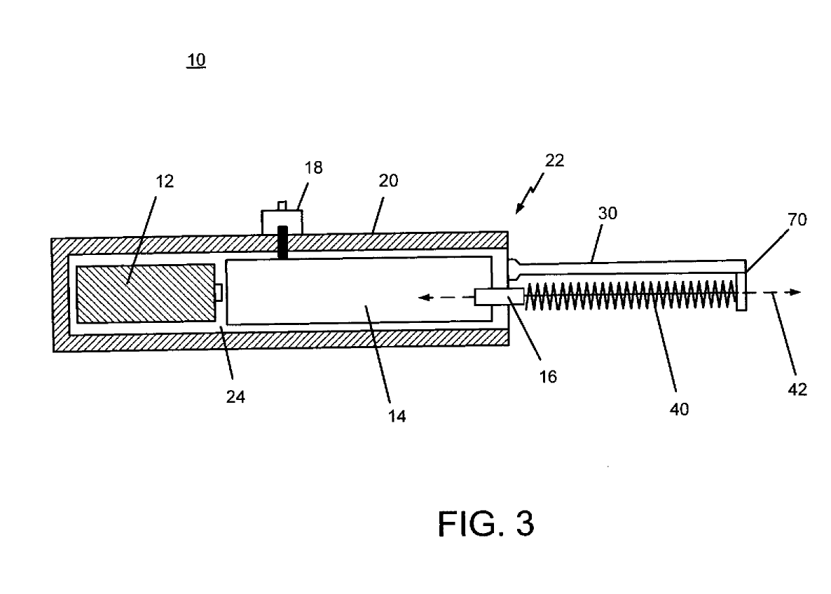

FIG. 3 is a cross-sectional illustration of the apparatus 10, in accordance with the first exemplary embodiment of the present disclosure. A stabilizing structure 70 may be included at the distal end of the peeling blade 30 and proximate to the distal end of the rotatable brush 40, wherein the rotatable brush 40 is rotatably mounted to the stabilizing structure 70. The stabilizing structure 70 may be constructed from any type of material and may be used to preserve clearance between the peeling blade 30 and the rotatable brush 40. The stabilizing structure 70 may flex or bend when the apparatus 10 is being used and the peeling blade 30 is contacting the structure being peeled. It is noted that the stabilizing structure 70 may be placed anywhere along the length of the peeling blade 30. Furthermore, the stabilizing structure 70 may be commonly used with the apparatus 10 powered by the electric motor 14, but it may be optionally included, depending on the intended use of the apparatus 10.

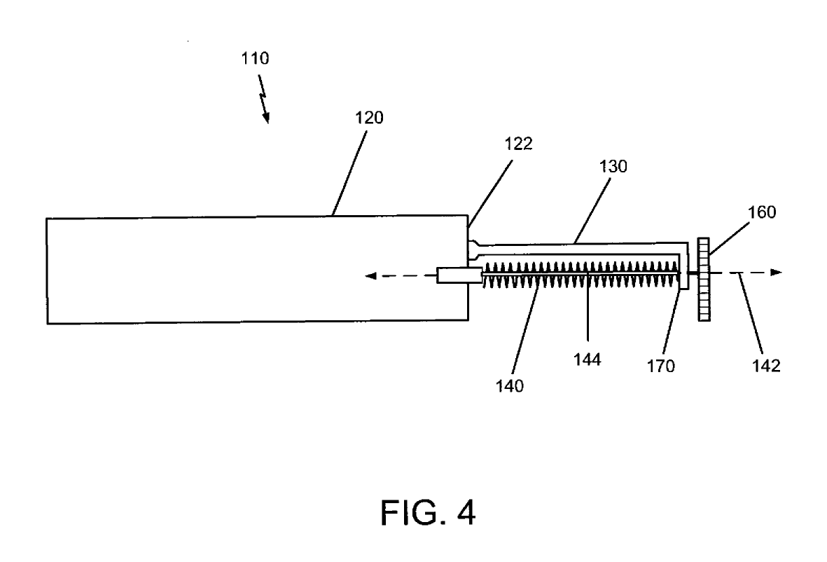

FIG. 4 is a cross-sectional illustration of a peeling apparatus 110, in accordance with a second exemplary embodiment of the present disclosure. The peeling apparatus 110, which may be referred to simply as ‘apparatus 110,’ may include any of the features, components, or functions discussed with respect to any other embodiment of this disclosure. The apparatus 110 has a handle 120. A peeling blade 130 is connected to a first end 122 of the handle 120. A rotatable brush 140 is positioned proximate to the peeling blade 130, wherein the rotatable brush 140 is rotatable about an elongated central axis 142, and wherein the elongated central axis 142 is substantially parallel to a length of the peeling blade 130.

In contrast to the apparatus 10 of FIGS. 1-2 which are powered with the electrical motor and power supply, the apparatus 110 of FIG. 3 may be kinetically powered. The apparatus 110 includes a central axle 144 through the rotatable brush 140 that is attached to a wheel 160 positioned at the non-attached end of the rotatable brush 140. The wheel 160 may have a sufficient radius to allow an edge to extend to or past the outer surface or contact surface of the peeling blade 130, thereby allowing the wheel 160 to contact the food product being peeled and rotate from the contact with that food product. The wheel 160 may be toothed or serrated, or have any other textural.

The wheel 160 may have a corresponding movement to the rotatable brush 140 such that the rotatable brush 140 and wheel 160 move together and in the same rotational direction. Accordingly, as the apparatus 110 is moved along a food product, the wheel 160 may contact the food product and rotate, and rotation of the wheel 160 will rotate the central axle 144, and thus rotate the rotatable brush 140. This rotation of the rotatable brush 40 may allow the peelings to be removed from a position between the peeling blade 130 and the rotatable brush 140. The peeling blade 130 may be the same or substantially similar to that described in the first exemplary embodiment, whereas the handle 120 may be a hollow or solid structure that attaches to the peeling blade 130 and the rotatable brush 140.

A stabilizing structure 170 may be included at the distal end of the peeling blade 130 and proximate to the distal end of the rotatable brush 140. The stabilizing structure 170 may be constructed from any type of material and may be used to preserve clearance between the peeling blade 130 and the rotatable brush 140. The stabilizing structure 170 may flex or bend when the apparatus 110 is being used and the peeling blade 130 is contacting the structure being peeled. It is noted that the stabilizing structure 170 may be placed anywhere along the length of the peeling blade 130. Furthermore, the stabilizing structure 170 may be optional with the apparatus 110, and may depend on the intended use of the apparatus 110. For example, the stabilizing structure 170 may not be needed when the wheel 160 sufficiently stabilizes the rotatable brush 140.

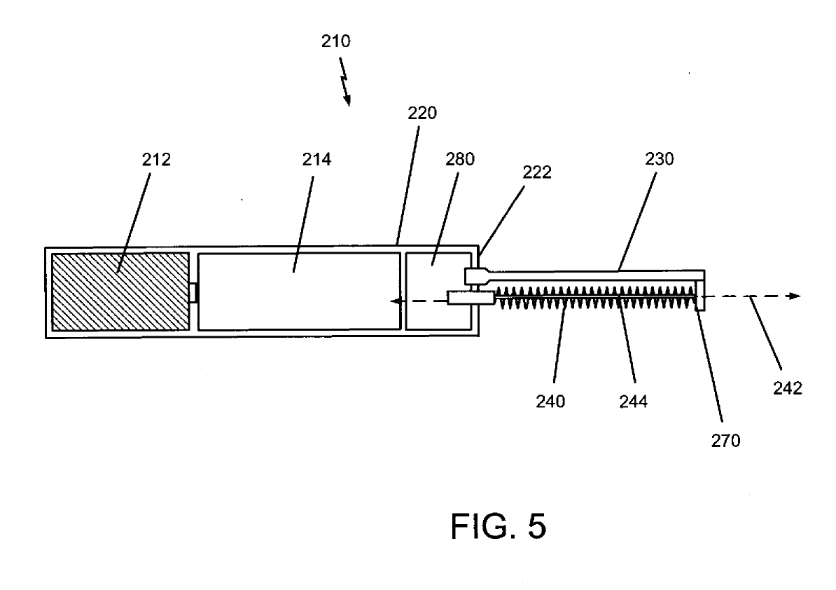

FIG. 5 is a cross-sectional illustration of a peeling apparatus 210, in accordance with a third exemplary embodiment of the present disclosure. The peeling apparatus 210, which may be referred to simply as ‘apparatus 210,’ may include any of the features, components, or functions discussed with respect to any other embodiment of this disclosure. The apparatus 210 has a handle 220. A peeling blade 230 is connected to a first end 222 of the handle 220. A rotatable brush 240 is positioned proximate to the peeling blade 230, wherein the rotatable brush 240 is rotatable about an elongated central axis 242, and wherein the elongated central axis 242 is substantially parallel to a length of the peeling blade 230. An optional stabilizing structure 270 may be included at the distal end of the peeling blade 230 and proximate to the distal end of the rotatable brush 240, wherein the rotatable brush 240 is rotatably mounted to the stabilizing structure 270.

As is shown in FIG. 5, the apparatus 210 may also include a vibration mechanism 280 which is capable or inducing a vibration within the apparatus 210, primarily within the peeling blade 230, but also within the rotatable brush 240. The vibration mechanism 280 may include any type of vibration device, such as sonic vibrator. The vibrations induced within the peeling blade 230 may increase peeling efficiency of the peeling blade 230. Any vibrations induced within the rotatable brush 240 may help move the peelings of the food product away from the space between the peeling blade 230 and the rotatable brush 240 and out of the slot within the peeling blade 230. The vibration mechanism 280 may be housed in any appropriate place on the apparatus 210, such as within the handle 220. Furthermore, the vibration mechanism 280 may be integral with the electric motor 214, such that one device rotates the rotatable brush 240 and induces vibrations within the peeling blade 230. As can be seen, the vibration mechanism 280 may be positioned close to the rotatable brush 240, in comparison to the power supply 212 and the electric motor 214, such that vibrations are efficiently passed through the axle 244 of the rotatable brush 240.

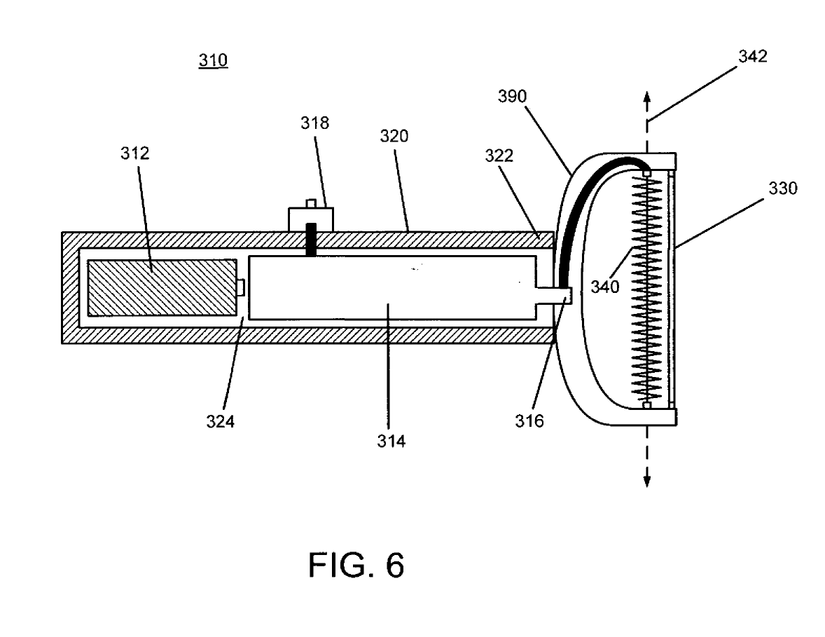

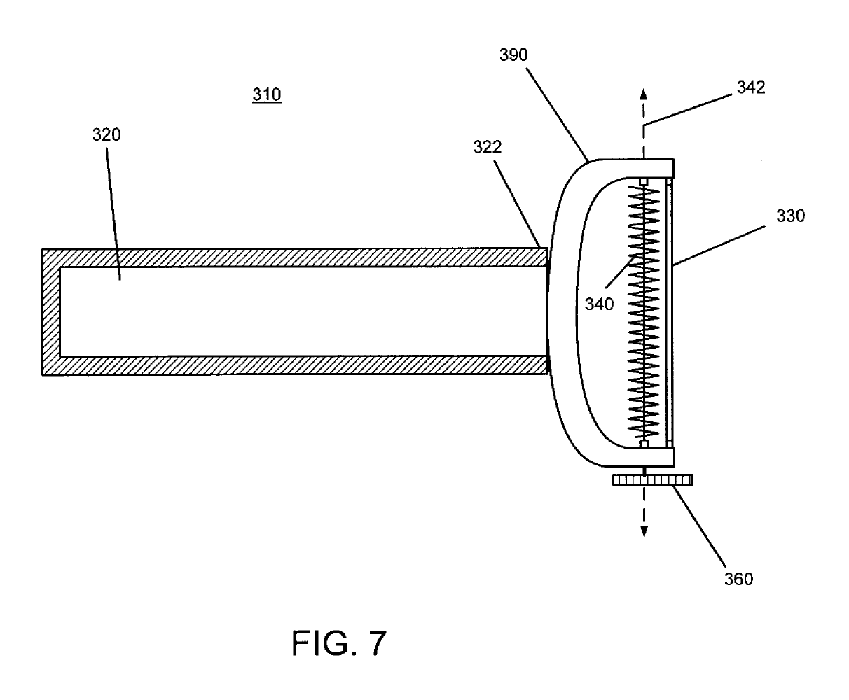

FIG. 6 is a cross-sectional illustration of a peeling apparatus 310, in accordance with a fourth exemplary embodiment of the present disclosure. FIG. 7 is a cross-sectional illustration of a peeling apparatus 310, in accordance with the fourth exemplary embodiment of the present disclosure. The peeling apparatus 310, which may be referred to simply as ‘apparatus 310,’ may include any of the features, components, or functions discussed with respect to any other embodiment of this disclosure. The apparatus 310 has a handle 320. A peeling blade 330 is connected to a first end 322 of the handle 320. A rotatable brush 340 is positioned proximate to the peeling blade 330, wherein the rotatable brush 340 is rotatable about an elongated central axis 342, and wherein the elongated central axis 342 is substantially parallel to a length of the peeling blade 330.

As is shown in FIGS. 6-7, the elongated central axis 342 of the rotatable brush 340 is positioned substantially perpendicular to a length of the handle 320, as opposed to the substantially parallel positioning depicted in FIGS. 1-5. The peeling blade 330 and rotatable brush 340 are connected to the handle 320 with a support member 390, which extends away from the first end 322 of the handle 320. The support member 390 has a Y-shape or forked shape, such that it can support either end of the peeling blade 330 and the rotatable brush 440. FIG. 6 depicts the apparatus 310 with the power supply 312, electric motor 314, rotatable connection 316, and activation switch 318, such that the rotatable brush 340 can be rotated electrically. In contrast, FIG. 7 depicts the apparatus 310 with kinetic rotation, whereby the wheel 360 may be moved along the food product to rotate the rotatable brush 340. The apparatus 310 of both FIG. 6 and FIG. 7 may function as described relative to FIGS. 1-5.

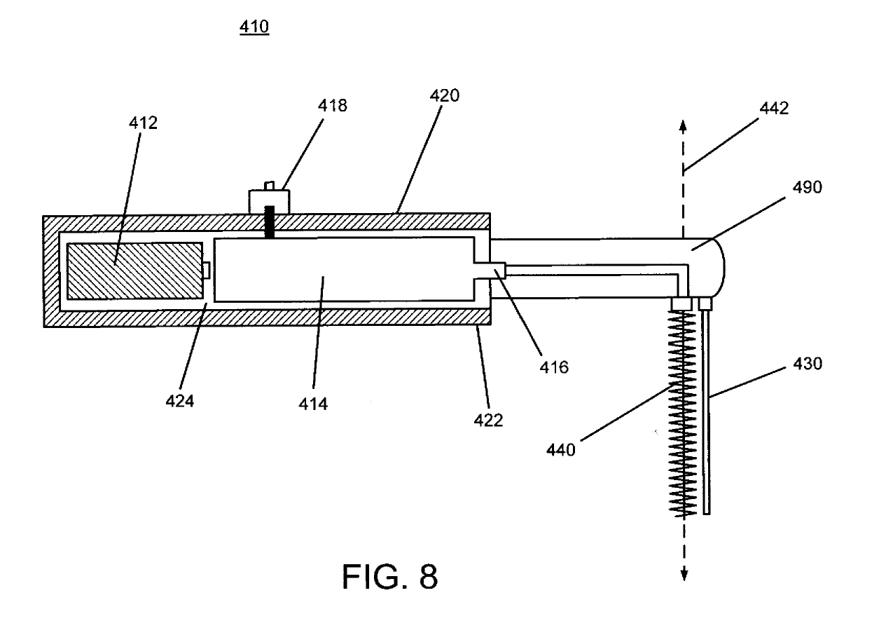

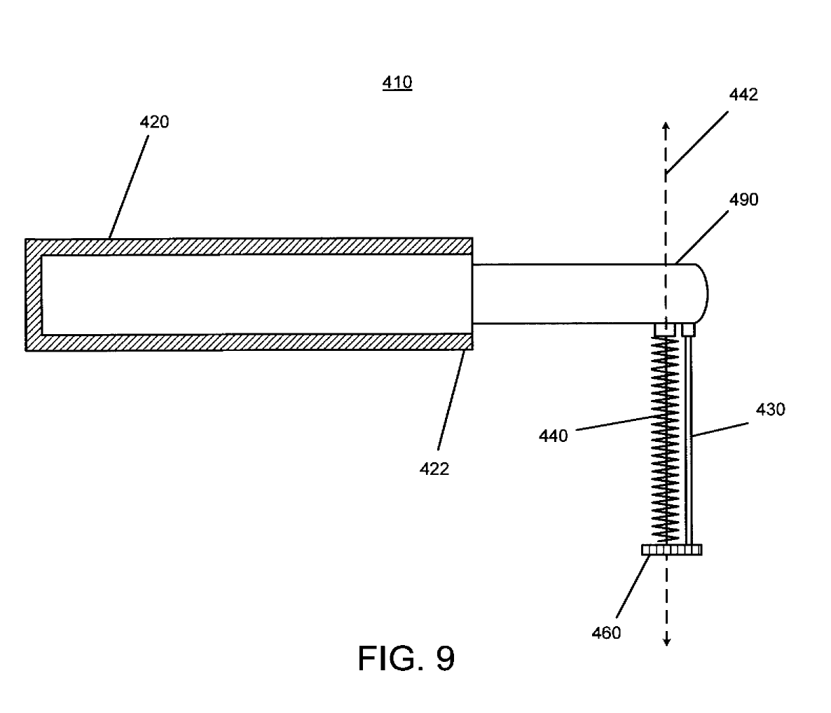

FIG. 8 is a cross-sectional illustration of a peeling apparatus 410, in accordance with a fifth exemplary embodiment of the present disclosure. FIG. 9 is a cross-sectional illustration of a peeling apparatus 410, in accordance with the fifth exemplary embodiment of the present disclosure. The peeling apparatus 410, which may be referred to simply as ‘apparatus 410,’ may include any of the features, components, or functions discussed with respect to any other embodiment of this disclosure. The apparatus 410 has a handle 420. A peeling blade 430 is connected to a first end 422 of the handle 420. A rotatable brush 440 is positioned proximate to the peeling blade 430, wherein the rotatable brush 440 is rotatable about an elongated central axis 442, and wherein the elongated central axis 442 is substantially parallel to a length of the peeling blade 430.

As is shown in FIGS. 8-9, the elongated central axis 442 of the rotatable brush 440 is positioned substantially perpendicular to a length of the handle 420, similarly to FIGS. 6-7 and as opposed to the substantially parallel positioning depicted in FIGS. 1-5. The peeling blade 430 and rotatable brush 440 are connected to the handle 420 with a support member 490, which extends away from the first end 422 of the handle 420. The support member 490 extends away from the first end 422 in a linear fashion to put position the peeling blade 430 and rotatable brush 440 a distance from the first end 422. FIG. 8 depicts the apparatus 410 with the power supply 412, electric motor 414, rotatable connection 416, and activation switch 418, such that the rotatable brush 440 can be rotated electrically. In contrast, FIG. 9 depicts the apparatus 410 with kinetic rotation, whereby the wheel 460 may be moved along the food product to rotate the rotatable brush 440. The apparatus 410 of both FIG. 8 and FIG. 9 may function as described relative to FIGS. 1-7.

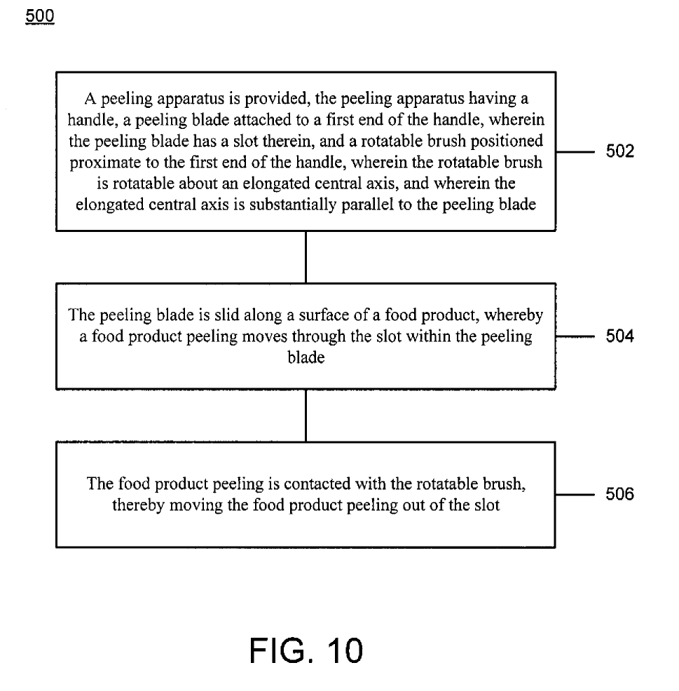

FIG. 10 is a flowchart 500 illustrating a method of peeling a food product, in accordance with a sixth exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 502, a peeling apparatus is provided, the peeling apparatus having a handle, a peeling blade attached to a first end of the handle, wherein the peeling blade has a slot therein, and a rotatable brush positioned proximate to the first end of the handle, wherein the rotatable brush is rotatable about an elongated central axis, and wherein the elongated central axis is substantially parallel to the peeling blade. The peeling blade is slid along a surface of a food product, whereby a food product peeling moves through the slot within the peeling blade (block 504). The food product peeling is contacted with the rotatable brush, thereby moving the food product peeling out of the slot (block 506).

The method may include a number of additional steps and processes, including any of the steps, processes, or functions disclosed within this disclosure. For example, an electric motor may be activated to rotate the rotatable brush continually, intermittently, or any combination thereof. In one of many alternatives, the rotatable brush may be rotated by contacting an edge of a wheel on a surface of the food product, wherein the wheel is connected to the rotatable brush. The rotatable brush may be stabilized with a stabilizing structure positioned on a distal end of the peeling blade, wherein the rotatable brush is rotatably mounted to the stabilizing structure. The peeling blade and/or the rotatable brush may also be vibrated with a vibration mechanism, such as s sonic vibration mechanism. The electric motor may be used as a vibration inducing device to induce vibrations into the peeling blade.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A peeling apparatus comprising:
a handle;
a peeling blade connected to a first end of the handle;
a rotatable brush positioned proximate to the peeling blade, wherein the rotatable brush is rotatable about an elongated central axis, and wherein the elongated central axis is substantially parallel to a length of the peeling blade.

2. The peeling apparatus of claim 1, further comprising a motor positioned within the handle, wherein activation of the motor rotates the rotatable brush.

3. The peeling apparatus of claim 2, further comprising an activation switch controlling activation of the motor, wherein the switch is positioned at least partially on an exterior surface of the handle.

4. The peeling apparatus of claim 2, further comprising a power supply at least partially housed within the handle, wherein the power supply is electrically connected to the motor.

5. The peeling apparatus of claim 1, further comprising a stabilizing structure positioned on a distal end of the peeling blade, wherein the rotatable brush is rotatably mounted to the stabilizing structure.

6. The peeling apparatus of claim 1, further comprising a wheel connected to the rotatable brush, wherein a center axis of the wheel substantially aligns with the elongated central axis of the rotatable brush, and wherein a rotation of the wheel rotates the brush.

7. The peeling apparatus of claim 6, wherein an edge of the wheel substantially aligns with a contact face of the peeling blade.

8. The peeling apparatus of claim 1, further comprising a vibration mechanism, wherein the vibration mechanism induces a vibration within at least one of the peeling blade and the rotatable brush.

9. The peeling apparatus of claim 8, wherein the vibration induced within the at least one peeling blade and rotatable brush further comprises a sonic vibration.

10. The peeling apparatus of claim 1, wherein the elongated central axis of the rotatable brush is positioned substantially parallel to a length of the handle.

11. The peeling apparatus of claim 1, wherein the elongated central axis of the rotatable brush is positioned substantially perpendicular to a length of the handle.

12. The peeling apparatus of claim 11, further comprising a support member connected between the rotatable brush and the first end of the handle.

13. The peeling apparatus of claim 12, wherein the support member further comprises a Y-shape.

14. A food product peeling apparatus comprising:
a handle having a substantially hollow interior portion;
an electric motor positioned within the hollow interior portion;
a battery positioned within the hollow interior portion and electrically connected to the electric motor;
an activation switch electrically connected to at least one of the electric motor and the battery, wherein activation of the activation switch rotates the electric motor;
an elongate peeling blade connected to a first end of the handle;
an elongate rotatable brush positioned substantially parallel to the elongate peeling blade, wherein the rotatable brush is rotatable about an elongated central axis, and wherein the elongated central axis is substantially parallel to a length of the peeling blade.

15. A method of peeling a food product, the method comprising the steps of:
providing a peeling apparatus having a handle, a peeling blade attached to a first end of the handle, wherein the peeling blade has a slot therein, and a rotatable brush positioned proximate to the first end of the handle, wherein the rotatable brush is rotatable about an elongated central axis, and wherein the elongated central axis is substantially parallel to the peeling blade;
sliding the peeling blade along a surface of a food product, whereby a food product peeling moves through the slot within the peeling blade; and
contacting the food product peeling with the rotatable brush, thereby moving the food product peeling out of the slot.

16. The method of claim 15, further comprising activating an electric motor to rotate the rotatable brush.

17. The method of claim 16, wherein the electric motor is activated intermittently.

18. The method of claim 15, further comprising rotating the brush by contacting an edge of a wheel on a surface of the food product, wherein the wheel is connected to the rotatable brush.

19. The method of claim 15, further comprising stabilizing the rotatable brush with a stabilizing structure positioned on a distal end of the peeling blade, wherein the rotatable brush is rotatably mounted to the stabilizing structure.

20. The method of claim 15, further comprising vibrating the peeling blade with a vibration mechanism.
